(19) United States
(12) Patent Application Publication
(10) Pub. No.: US 2026/0141179 A1
(43) Pub. Date: May 21, 2026

(54) SURVEY ANALYSIS

(71) Applicant: FMR LLC, Boston, MA (US)

(72) Inventors: Barry Maguire, Galway (IE); John C. McDonough, Nahant, MA (US); Ami Divyesh Khandeshi, Nashua, NH (US)

(21) Appl. No.: 18/948,876

(22) Filed: Nov. 15, 2024

(51) Int. Cl. G06F 40/30; G06F 16/35; G06F 21/62; G06F 40/284; G06Q 10/105

(52) U.S. Cl. CPC G06F 40/30; G06F 16/35; G06F 21/6245; G06F 40/284; G06Q 10/105

(57) ABSTRACT

A computerized method is provided for using large language models to analyze large amounts of survey data. An LLM can be used to generate sample survey results and then prompted to classify and assign a sentiment to those results. The LLM-generated classifications can be compared to manually tagged classifications for the same sample results and scored on correlation between the two. The LLM parameters can be optimized to maximize that correlation and the trained LLM can then be used to analyze real survey data.

### TECHNICAL FIELD

This application relates generally to systems, methods, and apparatuses, including computer program products, for automated analysis of survey data including through the use of a large language model (LLM).

### BACKGROUND

Large scale surveys are useful tools for evaluating feelings and opinions within any group. For example, understanding employee sentiment and adapting accordingly is important for attracting and retaining the best employees and ensuring employee buy-in and increasing loyalty and productivity. To that end, many employers implement periodic employee satisfaction surveys to provide insight into employee sentiment and identify areas for improvement. However, sifting through, sorting, understanding, and implementing changes based on such survey results can be labor intensive, especially in large corporations. Additionally, interpreting the results to glean insight and drive human resources policies can be nuanced and prone to human error.

Today much of the survey results process is dependent on manual human interpretation which is prone to bias. These biases include people inserting their personal feelings and experiences or their own desired outcomes as well as individuals tailoring the results interpretation to minimize blowback on themselves or their leaders.

### SUMMARY

Systems and methods of the invention provide a new use of a large language model (LLM) and a multi-stage pipeline to analyze responses to employee satisfaction, or other surveys. By automatically and accurately analyzing and classifying survey results, and even generating suggestions for improvement, systems and methods described herein can help reduce costs and increase the efficiency of running large surveys while unlocking key insights within survey data. Furthermore, by removing the subjective human review element, systems and methods of the invention can reduce or eliminate bias that might skew survey results.

In certain embodiments, a target set of responses and corresponding classifications along with the associated sentiment can be added to the LLM prompt using the few shot method. For example, the following information could be added: “I wish I was paid better” (response): Compensation (classification): Negative (sentiment) and “I have found the company's unconscious bias training very informative and useful” (response): Diversity_Inclusion (classification): Strongly Positive (sentiment)).

The pipeline can include stages to create sample responses, mask confidential data, estimate the full analysis cost, and perform the survey response analysis. In various embodiments, a post process step can be used to remove hallucinations from the classifications and assess the result of the analysis. An iterative training loop of analysis can be used to refine the model parameters such as system, user prompts, and response token size and the hyperparameters temperature and top_k. In some embodiments, systems and methods of the invention can generate a set of innovative suggestions for management to implement that would improve the associates' work experience based on the analyzed survey results.

For training, in various embodiments, an LLM may be employed to generate sample survey responses with different levels of sentiment. Sentiment can range from Strongly Negative, Negative, Neutral, Positive and Strongly Positive. The sample set can then be classified manually and/or fed back to the LLM for classification. A post processing step can be used to manually remove hallucinations and score the results based on correlation to expected sentiment and classification. This process can be repeated through any number of iterations to refine the prompts and other LLM properties (e.g., those mentioned above) to achieve the best correlation with the sample set.

Production analysis can include masking of confidential or sensitive information and cost estimation that can be performed manually or automated. The trained LLM can then be used to analyze the actual survey results. The real responses to the survey can be processed using the prompts and scripts generated in the training steps.

Another post processing step can be used to format the results and remove hallucinations. Negative responses can also be fed back to the LLM so that it can generate the suggestions workplace improvements or addressing other concerns of survey respondents in other survey scenarios.

As noted, in various embodiments, a cost estimation can be performed before the entire survey is analyzed. Using sample data set of responses (e.g., 100), the estimate for the full analysis of tens of thousands of responses or more can be accurately prepared. A tokenizer library may be used to obtain an average LLM token count for the system and user prompts as well as the provided employee response and the resulting classification. The known cost per token for any LLM model used in analysis can then be used to estimate the cost of a larger analysis.

Aspects of the invention can include a computerized method for analyzing survey results. Methods can include training a large language model (LLM) neural network to classify survey results and assign a sentiment. Training can comprise generating a sample set of survey responses; classifying and assigning a sentiment to each survey response in the sample set both manually and using a large language model (LLM); removing hallucinations; and scoring results based on correlation between manual and LLM classification and sentiment results. Methods can further include providing the trained LLM with a set of survey responses and prompting the LLM to assign and return a sentiment and classification category to each survey response in the set.

In various embodiments, methods may include providing the trained LLM with survey responses from the set returned with a negative sentiment and prompting the LLM to produce suggestions to improve sentiment. Methods can comprise automatically identifying and masking selected information in the survey results. The selected information can include personally identifiable information. In some embodiments, methods can include estimating cost for a survey analysis by using a tokenizer library to determine an average LLM token count for required prompts as well as a provided survey response and resulting classification; and extrapolating a total cost of a total analysis based on a number of survey responses in the set of survey responses.

In some embodiments, the training step can further comprise repeating the generating, classifying, removing, and scoring steps to refine the LLM. The classifying and assigning step can further comprise providing the LLM with a list of acceptable classification categories. The generating step may be performed by the LLM by prompting the LLM to return sample responses across a spectrum of sentiments. In certain embodiments, the training step can further include providing the LLM with a plurality of sample responses using a few-shot method. The plurality of sample responses may consist of two sample responses. Sentiments can be text-based sentiments selected from strongly negative, negative, neutral, positive, and strongly positive. Assigning a sentiment can include prompting for a numerical scoring of sentiment and then converting to the text-based sentiments. The set of survey responses can include at least 100 responses. In some embodiments, the set of survey responses may comprise at least 1.000 responses. In certain embodiments, the set of survey responses can include at least 5,000 responses. The survey responses can be obtained from an employee satisfaction survey in various embodiments. The suggestions can include recommendations for management to improve employee satisfaction.

In certain aspects, systems of the invention can include a computer system for analyzing survey results, the system comprising a processor in communication with a non-transient memory and operable to perform the steps of: training a large language model (LLM) neural network to classify survey results and assign a sentiment and providing the trained LLM with a set of survey responses and prompting the LLM to assign and return a sentiment and classification category to each survey response in the set. Training for the LLM by the system can comprise generating a sample set of survey responses; classifying and assigning a sentiment to each survey response in the sample set both manually and using a large language model (LLM); removing hallucinations; and scoring results based on correlation between manual and LLM classification and sentiment results. In various embodiments systems of the invention can be operable to perform any and all of the aforementioned methods.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for analyzing survey data.

FIG. 2 shows an exemplary method for analyzing survey data.

FIG. 3 illustrates an exemplary flow chart for training an LLM to analyze survey results.

FIG. 4 illustrates an exemplary flow chart for using a trained LLM to analyze survey results.

FIG. 5 shows an exemplary chart displaying LLM-produced and hand tagged survey analysis results along with a comparison thereof.

### DETAILED DESCRIPTION

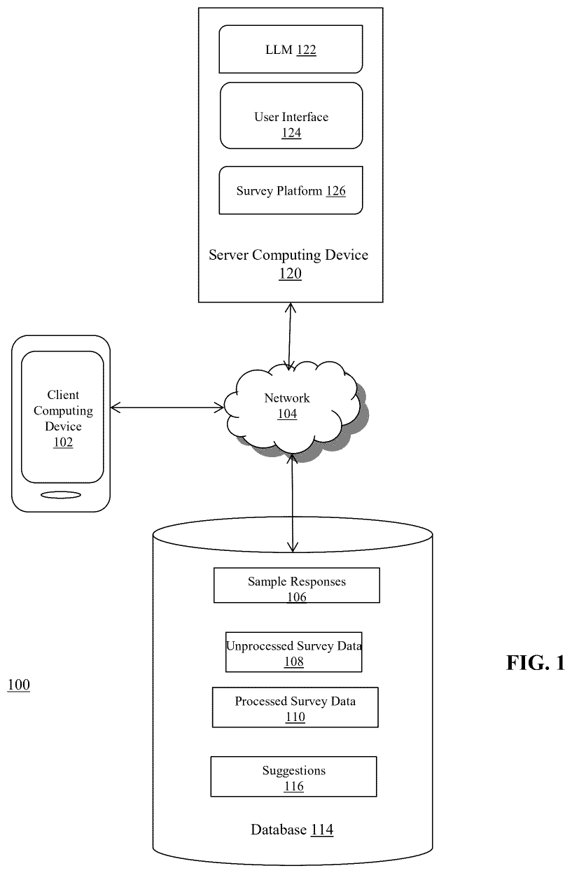

FIG. 1 is a block diagram of an exemplary system 100 for analyzing survey data. The system 100 includes a client computing device 102, a communications network 104, a server computing device 120 that includes a large language model 122, a user interface 124, and a survey platform 126 or application. The system 100 also includes a database 114 storing sample survey responses 106, generated suggestions 116, and processed 110 and unprocessed 108 survey data.

The client computing device 102 connects to one or more communications networks (e.g., network 104) in order to communicate with the server computing device 120 to provide input and receive output relating to survey analysis. Analysts, survey takers, or other users may interact with the survey data (108, 110), the LLM 122, and/or the survey platform 126 via a client computing device 102. For example, a user interface 124 hosted on the server computing device 120 or the client computing device 102 one or more input/output devices can allow the user to enter queries, enter or review survey responses, and review survey classification and sentiment data and suggestions among other actions.

Exemplary client computing devices 102 include but are not limited to server computing devices, desktop computers, laptop computers, tablets, mobile devices, smartphones, and the like. Typically, the client computing device 102 includes a display device (not shown) that is embedded in and/or coupled to the client computing device for the purpose of displaying information to a user of the device. It should be appreciated that other types of computing devices that are capable of connecting to the components of the system 100 can be used without departing from the scope of invention. Although FIG. 1 depicts one client computing device 102, it should be appreciated that the system 100 can include any number of client computing devices.

In some embodiments, the client computing device 102 can execute one or more software applications that are used in conjunction with applications or modules on the server computing device 120. For example, the client computing device 102 can be configured to execute one or more native applications and/or one or more browser applications. Generally, a native application is a software application (in some cases, called an ‘app’) that is installed locally on the client computing device 102 and written with programmatic code designed to interact with an operating system that is native to the client computing device 102. Such software may be available from, e.g., the Apple® App Store, the Google® Play Store, the Microsoft® Store, or other software download platforms depending upon, e.g., the type of device used. In some embodiments, the native application includes a software development kit (SDK) module that is executed by a processor of the client computing device 102 to perform functions (e.g., enter or approve time worked or request time off). Generally, a browser application comprises software executing on a processor of the client computing device 102 that enables the client computing device to communicate via HTTP or HTTPS with remote servers addressable with URLs (e.g., server computing device 120) to receive website-related content, including one or more webpages, for rendering in the browser application and presentation on the display device coupled to the client computing device 102. Exemplary mobile browser application software includes, but is not limited to, Firefox™, Chrome™, Safari™, and other similar software. The one or more webpages can comprise visual and audio content for display to and interaction with a user.

The communications network 104 enables the client computing device 102 to communicate with the server computing device 120 and the database 114 in certain embodiments. The network 104 is typically comprised of one or more wide area networks, such as the Internet and/or a cellular network, and/or local area networks. In some embodiments, the network 104 is comprised of several discrete networks and/or sub-networks (e.g., cellular to Internet).

The server computing device 120 is a device including specialized hardware and/or software modules that execute on a processor and interact with memory modules of the server computing device 120, to receive data from other components of the system 100, transmit data to other components of the system 100, and perform functions (e.g., survey result classification and sentiment analysis). As discussed above the server computing device 120 includes the LLM 122, the user interface 124, and the survey platform 126 or application along with any number of other programs that may execute on the processor of the server computing device 120 and may each, despite being disparate programs, rely on a regular exchange of data between them and/or the database 114. In various embodiments, survey data may be generated internally using a survey platform 126 or may be obtained from an external source such as a third party vendor that may administer a survey. In some embodiments, the various modules, programs, or applications are specialized sets of computer software instructions programmed onto one or more dedicated processors in the server computing device 120 and can include specifically designated memory locations and/or registers for executing the specialized computer software instructions.

Although the applications and modules are shown in FIG. 1 as executing within the same server computing device 120, in some embodiments the functionality of the applications and modules can be distributed among a plurality of server computing devices. It should be appreciated that any number of computing devices, arranged in a variety of architectures, resources, and configurations (e.g., cluster computing, virtual computing, cloud computing) can be used without departing from the scope of the invention. The exemplary functionality of the applications, programs, and/or modules is described in detail throughout this specification.

The database 114 is a computing device (or in some embodiments, a set of computing devices) coupled to the server computing device 120 and is configured to receive, generate, and store specific segments of data relating to survey data analysis. In some embodiments, all or a portion of the database 114 can be integrated with the server computing device 120 or be located on a separate computing device or devices. The database 114 can comprise one or more databases configured to store portions of data used by the other components of the system 100, as will be described in greater detail below.

In some embodiments, the database 114 comprises a repository for sample survey responses 106. As discussed below, these responses can be used to train the LLM 122 to classify and assign sentiment to actual survey responses. The sample responses 106 may themselves be generated by the same LLM 122 or obtained from another LLM or source. The database 114 can also include unprocessed survey data 108 that may include the raw survey results without classification or other annotations. The LLM 122 can draw from this pool to provide analysis. A repository of processed survey data 110 in the database 114 can be used to store the results of the LLM's 122 analysis including classification and sentiment data assigned to the responses and any statistical summaries or other information resulting from the analysis. Additionally, where the LLM 122 is used to generate suggestions in response to the processed survey data 110, those suggestions for improvements can be stored in a suggestions repository 116 in the database 114.

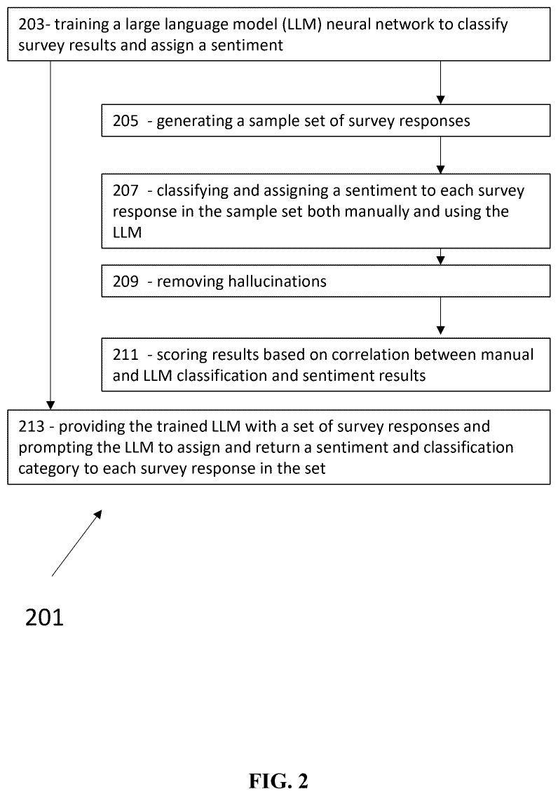

FIG. 2 shows an exemplary method 201 for analyzing survey results. The method 201 can include training 203 a large language model (LLM)) neural network to classify survey results and assign a sentiment. Training 203 can include generating 205 a sample set of survey responses, classifying and assigning a sentiment 207 to each survey response in the sample set both manually and using the LLM, removing 209 hallucinations, and scoring 211 results based on the correlation between manual and LLM classification and sentiment results. The trained LLM can then be provided 213 with a set of real survey responses and prompted to assign and return a sentiment and classification category to each of response in the set.

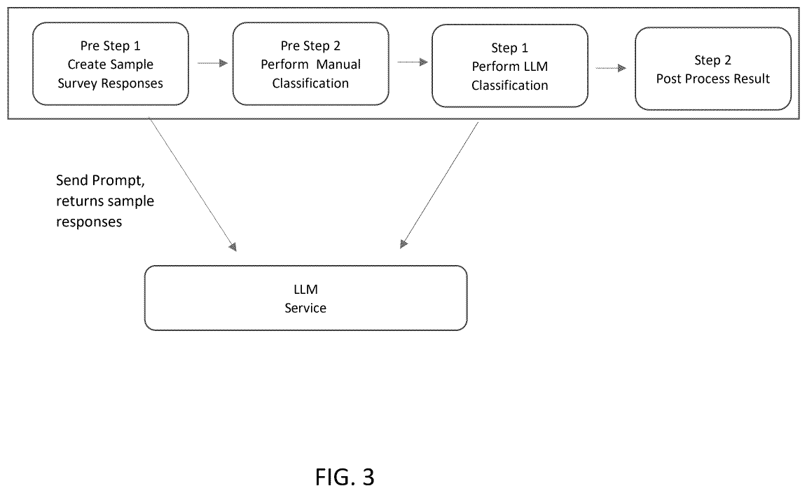

FIG. 3 illustrates an exemplary flow chart for training an LLM to analyze survey results. In pre step one, an LLM service is prompted to create sample survey responses. Pre step two involves manual classification of the returned sample survey responses. Step one includes prompting the LLM service to classify the returned sample survey responses. Step two includes post processing wherein hallucinations are removed and the manual classifications and LLM classifications for each sample response are compared and scored based on correlation. This process can be iterated any number of times in order to refine the prompts used and other LLM properties to achieve the best correlation between manual classifications and sentiment analyses and the LLM classifications and sentiment analyses.

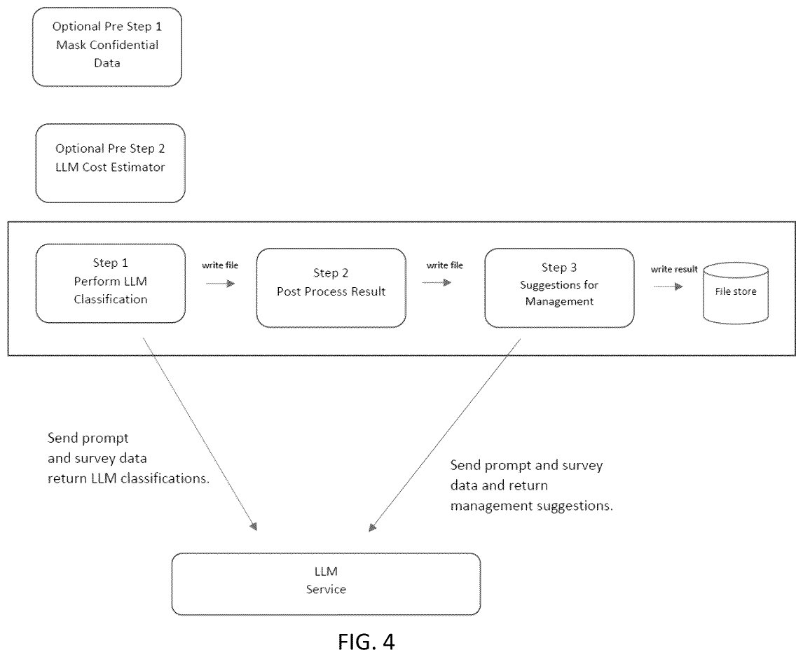

FIG. 4 illustrates an exemplary flow chart for using a trained LLM to analyze survey results. Optional pre steps can be used to mask confidential data (e.g., remove personally identifiable information (PII)) and/or perform a cost estimation based on a sample subset of the survey results to be analyzed as discussed above. Either of the optional pre steps can be performed manually or automated as discussed above. The trained LLM can then be provided with the survey data and prompted to return LLM classifications and assign sentiments to each of the survey results. The prompts and LLM properties refined in the training steps can be used to provide the most accurate classifications and sentiment analyses. A survey analysis file can be written including the LLM-provided classifications and sentiments and reviewed in post processing to remove any further hallucinations (e.g., assignment of sentiments or categories outside of those provided in the prompting). The trained LLM can be further prompted with the survey data to provide recommendations to address concerns or issues identified in the survey data. All results may be stored in a database file as discussed above. The aforementioned steps are discussed in further detail below.

In order to obtain sample responses for training purposes, the LLM can be used to create sample data. For example, the following code may be used to generate sample survey responses:

```
system_prompt = [
    “You are an AI language model trained to provide long sample employee responses to an
employee satisfaction survey.”,
    “Your response should be in JSON format.”,
    “Don't reply with anything other than the JSON object.”
]
numberOfResponses = 10
targetSentiment = “Strongly Negative”
response = openai.ChatCompletion.create(
  engine=OPENAPI_ENGINE,
  messages = [{“role”:“system”, “content”:‘\n’.join(system_prompt)},
  {“role”:“user”,“content”: f“List {numberOfResponses} long detailed {targetSentiment}
employee responses to an employee satisfaction survey.”}],
  temperature=0.7,
  max_tokens=4000,
  top_p=0.95,
  frequency_penalty=0,
  presence_penalty=0,
  stop=None)
result = json.loads(response[“choices”][0][“message”][“content”].strip( ))
```

In various embodiments, hundreds of sample employee responses with different sentiments ranging from Strongly Negative to Strongly Positive can be generated accordingly. Exemplary LLM generated response are shown in Table 1 below.

TABLE 1

| Sentiment | LLM Generated Employee Response |
|---|---|
| Positive | I absolutely love working for this company! The culture is |
| | fantastic, and the management truly cares about their |
| | employees. The benefits package is excellent, and the work- |
| | life balance is perfect. I couldn't ask for a better place to |
| | work! |
| Neutral | Overall, I would say that I am satisfied with my job. There are |
| | certainly aspects of it that I enjoy and find fulfilling, and I |
| | appreciate the stability and benefits that come with working |
| | here. However, there are also some areas where I think there |
| | is room for improvement. For example, I feel that |
| | communication between different departments could be better, |
| | and there are times when it seems like there is a lack of |
| | clarity around goals and expectations. Overall, though, I am |
| | happy to be a part of this company and am committed to |
| | doing my best work. |
| Negative | I feel undervalued and underappreciated in my role. Despite |
| | putting in long hours and going above and beyond, I have not |
| | received any recognition or opportunities for growth within |
| | the company. |

In various embodiments, sample survey responses can be obtained from prior surveys or created manually. Once a sample set of survey responses is obtained, they can be provided to the LLM along with a prompt to establish a general sentiment and subsequent classification with sentiment scores for the sample responses. This process can be repeated through numerous iterations of system and user prompts.

In various embodiments, the responses can be provided in a few-shot learning technique. Few-shot prompting includes prompting an LLM to solve a new task such as survey response analysis (e.g., classification and sentiment analysis) while providing examples of how the task should be solved (e.g., manually classified survey samples). In certain embodiments, the prompting can be two-shot. Surprisingly, adding more than two example responses was not found to improve the subsequent correlation score with the hand classified model.

In certain embodiments, sentiment prompting may be for a numerical score before converting that returned numerical score back to a text-based sentiment score in post processing (e.g., 1=positive, 2=very positive, −1=negative, −2=very negative). Surprisingly, asking for a numerical scoring of sentiment and converting it back to text in post process provided an improvement in correlation to the hand classified model over directly prompting the LLM for text-based sentiment scoring. Any commercially available LLM may be used with systems and methods of the invention including generative pre-trained transformer (GPT) models.

The following is exemplary code used to prompt the LLM to analyze sample survey responses:

```
@retry(delay=1, backoff=2, max_delay=120)
def classify(employeeResponse):
  “““Classify the employee response using the LLM ”””
  classification = None
  messages = [
      {“role”: “system”, “content”: f“““
      You are a HR manager tasked with analyzing responses to an employee satisfaction survey
      For each response you should classify the response and assign each classification a
sentiment value as well as assigning an overall sentiment.
      #
      Only return classifications from the list provided.
      Return at least two classifications for each response.
      You should only return a single sentiment number from −2 (Strongly Negative) to 2
(Strongly Positive)
      Do not return a sentiment without an associated classification
      Do not return any classification that is not on the list below
      #
      Classify the response into one of the following categories, do not return a classification that
is not on this list:
      Benefits
      Career
      Caregiving
      Challenging_Work
      Collaboration
      Communication
      Community_Culture
      Compensation
      Customers
      Diversity_Inclusion
      Dynamic_Working
      External_Factors
      Workplace
      Illness
      Leadership
      Learning_Development
      Manager
      Market
      Mental_Health
      Org_Changes
      Performance
      Productivity
      Recognition
      Reputation
      Shift
      Staffing
      Team
      Technology
      Training
      Travel
      Work_Life_Balance
      Working_From_Home
      Office_Facilities
      ”””
      },
      {“role”:“user”,“content”:“Employee Response: I need to get paid more”},
      {“role”:“assistant”,“content”:“Overall_Sentiment: −1\nClassifications: Compensation: −1”},
      {“role”:“user”,“content”:“Employee Response: No engagement, Pointlessness of being
there. Manager has not been response to my request for extra donuts”},
      {“role”:“assistant”,“content”:“Overall_Sentiment: −2\nClassifications: Dynamic_Working: −
2,Manager: −2”},
      {“role”:“user”,“content”:“Employee Response: Great work-life balance, perfect amount of
challenge to stay stimulated and performing”},
      {“role”:“assistant”,“content”:“Overall_Sentiment: 2\nChallenging_Work:
2,Work_Life_Balance: 2\n”},
      {“role”: “user”, “content”: f“““
      Employee Response: {employeeResponse}
      ”””
      }
  ]
  response_text = openai.ChatCompletion.create(
    engine=OPENAPI_ENGINE,
    messages=messages,
    request_timeout=30,
    temperature=0,
    top_p=0,
    max_tokens=800,
    n=1,
    stop=None)
  result = response_text[“choices”][0][“message”][“content”]
  return result
# Read the employee responses
df = pd.read_csv(‘MarchFinal_100.csv’, delimiter=‘,’, encoding = “utf-8” )
# Classify them
df[‘LLM_Result’] = df[‘Q2’].map(classify)
# Write the classificaitons to a file
df.to_csv(‘gpt4_classification_result.tsv’, sep=‘\’, columns=[‘Responseld’,‘Q1’,‘Q2’,‘Q2 -
Sentiment’,‘LLM_Result’,‘Q2 - Topic Sentiment Score’], index=False)
```

Exemplary LLM classification results are shown in Table 2:

TABLE 2

| | LLM | LLM Classification |
|---|---|---|
| Sample Employee Response | Sentiment | with sentiment |
| It was busy and productive! | Positive | Productivity: 1, |
| | | Workload: 1 |
| Visiting the office in and being able to | Very | Collaboration: 2, |
| meet in-person with my business | Positive | Travel: 2 |
| partners and squad members was | | |
| fantastic. | | |
| I need to get paid more | Negative | Compensation: −1 |
| Market volatility. Ongoing org | Negative | Market: −1, |
| challenges | | Org_Changes: −1 |
| My training team and facilitators are | Very | Training: 2 |
| great | Positive | |
| I work with a great manager and a good | Very | Manager: 2, |
| team | Positive | Team: 2 |
| Got a lot of important work done. Good | Very | Challenging_Work: |
| team. Good manager. | Positive | 2, Manager: 2, |
| | | Productivity: 2, |
| | | Team: 2 |

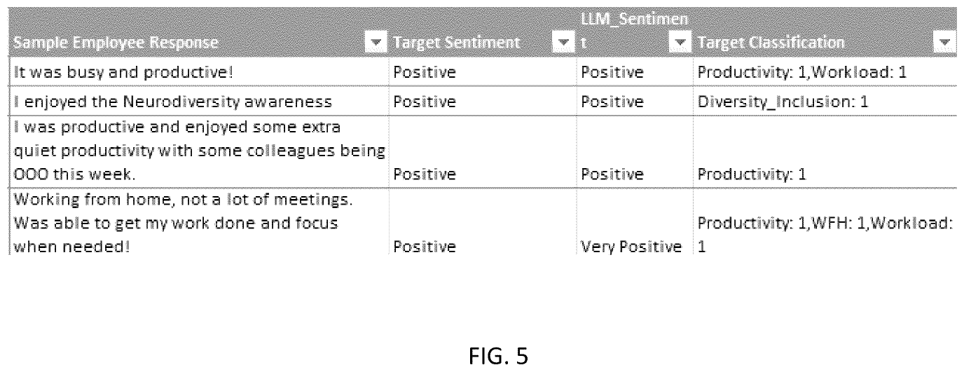

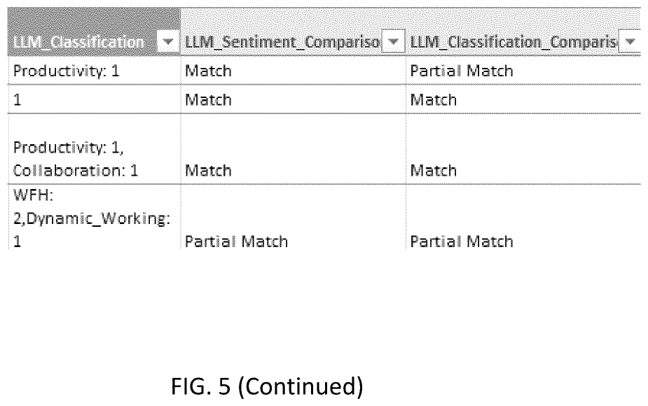

After receiving the LLM classifications, post processing can allow for formatting the generated classifications and sentiment values and for the removal of any hallucinated classifications. A comparison can be performed between the hand or manually tagged training data and the LLM results. An exemplary result comparison/scoring is shown in FIG. 5. Columns display each sample survey response along with the target (e.g., hand tagged) classifications and sentiment along with the LLM classifications and sentiments for that response. Additional columns can display the comparison score between the target and LLM classifications and sentiments (e.g., match, partial match, or mismatch). Exemplary code for post processing steps according to certain embodiments follows:

```
import os
import openai
import json
from retry import retry
import pandas as pd
import re
import sys
import numpy as np
classificationList = [
  “Benefits”,
  “Career”,
  “Caregiving”,
  “Challenging_Work”,
  “Collaboration”,
  “Communication”,
  “Community_Culture”,
  “Compensation”,
  “Customers”,
  “Diversity_Inclusion”,
  “Dynamic_Working”,
  “External_Factors”,
  “Workplace”,
  “Illness”,
  “Leadership”,
  “Learning_Development”,
  “Manager”,
  “Market”,
  “Mental_Health”,
  “Org_Changes”,
  “Performance”,
  “Productivity”,
  “Recognition”,
  “Reputation”,
  “Shift”,
  “Staffing”,
  “Team”,
  “Technology”,
  “Training”,
  “Travel”,
  “Work_Life_Balance”,
  “Working_From_Home”,
  “Office_Facilities”
]
#
# Count the number of matched classifications between the LLM model and the hand written
training model
#
def compare_classifications(series):
  if series.size != 2:
    return “N/A”
  result = “No Match”
  llm = series [0]
  hand = series[1]
  if pd.isna(hand):
    return “No Hand tagged classifications”
  if not llm or pd.isna(llm):
    return “No LLM classifications”
  pairs = hand.split(‘,’)
  matchCount = 0
  for pair in pairs:
    key, value = pair.split(‘:’)
    key = key.strip( )
    if key in llm:
      matchCount+=1
  if matchCount > 0:
    result = “Partial Match”
  if matchCount == len(pairs):
    result = “Match”
  return result
#
# Compare the sentiment in the hand-made training model to the LLM
#
def compare_sentiment(series):
  if series.size != 2:
    return “N/A”
  result = “No Match”
  llm = series[0]
  hand = series[1]
  if pd.isna(hand):
    return “No training model sentiment”
  if not llm or pd.isna(llm):
    return “No LLM sentiment”
  if hand == llm:
    result = “Match”
  else:
    hand = hand.replace(“Mixed”, “Neutral”)
    hand = hand.replace(“Very ”,“”)
    llm.replace(“Very ”,“”)
    if hand in llm:
      result = “Partial Match”
  return result
#
# Extract the sentiment number and convert to a string
#
def extract_sentiment(line):
  “““ Extract the sentiment number and convert to a string ”””
  # searching for the overall sentiment in the line
  match = re.search(r“Overall_Sentiment:\s*(-?\d)”, line)
  # extracting the integer value from the match
  sentiment = “0”
  if (match):
    sentiment = match.group(1)
  sentiment_map = {
    “−2”: “Very Negative”,
    “−1”: “Negative”,
    “0”: “Neutral”,
    “1”: “Positive”,
    “2”: “Very Positive”,
  }
  return sentiment_map.get(sentiment)
#
# If the LLM hallucinated a classification remove it
#
def remove_non_matching_classifications(llmString):
  split_strings = llmString.split(‘,’)
        filtered_strings = [s for s in split_strings if any(item in s for item in classificationList)]
  filtered_strings = ‘,’.join(filtered_strings)
  if filtered_strings != llmString:
    print(“Filtered: ”+filtered_strings)
    print(“llmString: ”+llmString)
  return filtered_strings
#
# Extract the section of the LLM response with classifications in it
#
def extract_classification(line):
  # searching for the overall sentiment in the line
  match = re.search(r“Classifications:\s*(.*)”, line)
  # extracting the classification
  classification = “No classifications found”
  if (match):
    classification = match.group(1)
  else:
    classification = “No classifications found”
    return classification
  classification = remove_non_matching_classifications(classification)
  return classification
###############################################
# Main
#
# Read in the classification result from the preceding step
df = pd.read_csv(‘gpt4_classification_result.tsv’, delimiter=‘\t’)
# Extract the sentiment
df[‘LLM_Sentiment’] = df[‘LLM_Result’].map(extract_sentiment)
# Extract the classifications and remove any hallucinated classes
df[‘LLM_Classification’] = df[‘LLM_Result’].map(extract_classification)
# Write the results to a file
df.to_csv(‘gpt4_classification_result_postprocess.tsv’, sep=‘\t’,
columns=[‘ResponseId’,‘Q1’,‘Q2’,‘Q2 - Sentiment’,‘LLM_Sentiment’,‘Q2 - Topic Sentiment
Score’,‘LLM_Classification’], index=False)
# Run an analysis comparing the classifications and sentiment analysis to the training data
df = pd.read_csv(‘gpt4_classification_result_postprocess.tsv’, delimiter=‘\t’)
df[‘LLM_Classification_Comparison’] = df[[‘LLM_Classification’,‘Q2 - Topic Sentiment
Score’]].apply(compare_classifications,axis=1)
df[‘LLM_Sentiment_Comparison’] = df[‘LLM_Sentiment’,‘Q2 -
Sentiment’]].apply(compare_sentiment,axis=1)
df.to_excel(‘pp.xlsx’, columns=[‘ResponseId’,‘Q1’,‘Q2’,‘Q2 - Sentiment’,‘LLM_Sentiment’,‘Q2 -
Topic Sentiment
Score’,‘LLM_Classification’,‘LLM_Sentiment_Comparison’,‘LLM_Classification_Comparison’],
index=False)
```

As discussed above, in certain embodiments, systems and methods may provide suggestions for management to address issues raised in the survey results using the LLM. Exemplary code for generating such suggestions follows: def suggestimprovments (employeeResponse1, employeeResponse2):

```
  “““
  Generates innovative and unusual changes that the HR management team could implement to
address an employee's concern.
  Args:
    employeeResponse1 (str): The response to the first question of the employee satisfaction
survey.
    employeeResponse2 (str): The response to the second question of the employee satisfaction
survey.
  Returns:
    str: The generated suggestions for HR management.
  ”””
  prompt = [
    {“role”: “system”, “content”: “““
    You are a HR manager tasked with analyzing responses to an employee satisfaction survey
    For each employee response provide three innovative and unusual changes the HR
management team could implement to address the employee's concern.
    ”””
    },
    {“role”: “user”, “content”: f“““
    Question 1: How was your week at work ? Employee Response: {employeeResponse1}.
    Question 2: What primary factor(s) contributed to your response? Employee Response:
{employeeResponse2}
    ”””
    }
  ]
  response_text = openai.ChatCompletion.create(
    engine=OPENAPI_ENGINE,
    messages=prompt,
    request_timeout=20,
    temperature=0.8,
    top_p=1,
    max_tokens=2000,
    n=1,
    stop=None)
  result = response_text[“choices”][0][“message”][“content”]
  return result
df = pd.read_csv(‘March_Negatives_test.tsv’, delimiter=‘\t’, encoding=“utf-8”)
df[‘LLM_Suggestions'] = df.apply(lambda x: suggestImprovments(x[‘Q1’], x[‘Q2’]), axis=1)
df.to_csv(‘gpt4_suggestions_1.tsv’, sep=‘\t’, columns=[‘ResponseId’, ‘LLM_Suggestions'],
index=False)
```

Exemplary responses as well as their classification and suggestions generated in using automated systems and methods herein are provided below:

1. Response: Heavy call volumes and unusual requests lowered stats and were mentally draining
Classification: Mental Health −2, Workload −2
Model Suggestion: Introduce a “Call Swap” program: Allow employees to voluntarily swap calls with their colleagues during mentally draining periods using an app or internal platform.

2. Response: Too many emails.
Classification: Workload: −1

Model Suggestion: Implement an AI-powered email filtering system: This system would automatically categorize emails based on their importance and relevance

3. Response: It was EXTREMELY loud in my business unit with everyone so close and everyone on the phones at the same time.

Classification: Productivity: −2, Office_Facilities: −2

Model Suggestion: Implement a noise-cancelling headphone policy: Provide each employee with high-quality noise cancelling headphones to help them focus and block out distractions in the office.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC

(Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile computing device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile computing device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computerized method for analyzing survey results, the method comprising:
training a large language model (LLM) neural network to classify survey results and assign a sentiment by:
generating a sample set of survey responses;
classifying and assigning a sentiment to each survey response in the sample set both manually and using the LLM;
removing hallucinations; and
scoring results based on correlation between manual and LLM classification and sentiment results; and
providing the trained LLM with a set of survey responses and prompting the LLM to assign and return a sentiment and classification category to each survey response in the set.

2. The computerized method of claim 1, further comprising providing the trained LLM with survey responses from the set returned with a negative sentiment and prompting the LLM to produce suggestions to improve sentiment.

3. The computerized method of claim 1, further comprising automatically identifying and masking selected information in the survey results.

4. The computerized method of claim 3, wherein the selected information comprises personally identifiable information.

5. The computerized method of claim 1, further comprising estimating cost for a survey analysis by:
using a tokenizer library to determine an average LLM token count for required prompts as well as a provided survey response and resulting classification;
extrapolating a total cost of a total analysis based on a number of survey responses in the set of survey responses.

6. The computerized method of claim 1, wherein the training step further comprises repeating the generating, classifying, removing, and scoring steps to refine the LLM.

7. The computerized method of claim 1, wherein the classifying and assigning step further comprises providing the LLM with a list of acceptable classification categories.

8. The computerized method of claim 1, wherein the generating step is performed by the LLM by prompting the LLM to return sample responses across a spectrum of sentiments.

9. The computerized method of claim 1, wherein the training step further comprises providing the LLM with a plurality of sample responses using a few-shot method.

10. The computerized method of claim 9, wherein the plurality of sample responses consists of two sample responses.

11. The computerized method of claim 1, wherein sentiments are text-based sentiments selected from strongly negative, negative, neutral, positive, and strongly positive.

12. The computerized method of claim 11, wherein assigning a sentiment comprises prompting for a numerical scoring of sentiment and then converting to the text-based sentiments.

13. The computerized method of claim 1, wherein the set of survey responses comprises at least 100 responses.

14. The computerized method of claim 13, wherein the set of survey responses comprises at least 1,000 responses.

15. The computerized method of claim 14, wherein the set of survey responses comprises at least 5,000 responses.

16. The computerized method of claim 2, wherein the survey responses are obtained from an employee satisfaction survey.

17. The computerized method of claim 2, wherein the suggestions comprise recommendations for management to improve employee satisfaction.

18. A computer system for analyzing survey results, the system comprising a processor in communication with a non-transient memory and operable to perform the steps of:
training a large language model (LLM) neural network to classify survey results and assign a sentiment by:
generating a sample set of survey responses;
classifying and assigning a sentiment to each survey response in the sample set both manually and using the LLM;
removing hallucinations; and
scoring results based on correlation between manual and LLM classification and sentiment results; and
providing the trained LLM with a set of survey responses and prompting the LLM to assign and return a sentiment and classification category to each survey response in the set.

19. The computer system of claim 18, further operable to provide the trained LLM with survey responses from the set returned with a negative sentiment and prompting the LLM to produce suggestions to improve sentiment.

20. The computer system of claim 18, further operable to estimate cost for a survey analysis by:
using a tokenizer library to determine an average LLM token count for required prompts as well as a provided survey response and resulting classification;
extrapolating a total cost of a total analysis based on a number of survey responses in the set of survey responses.

21. The computer system of claim 18, wherein the generating step is performed by the LLM by prompting the LLM to return sample responses across a spectrum of sentiments.
